(19) United States
(12) Patent Application Publication
(10) Pub. No.: US 2013/0318169 A1
(43) Pub. Date: Nov. 28, 2013

(54) COMPUTING DEVICE AND COOPERATIVE DRAWING METHOD

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: CHUNG-I LEE, New Taipei (TW); HAI-HONG LIN, Shenzhen (CN); DE-YI XIE, Shenzhen (CN); HAI-YUN CHEN, Shenzhen (CN); HAI-TAO TONG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/869,349

(22) Filed: Apr. 24, 2013

(30) Foreign Application Priority Data
May 23, 2012 (CN) 2012101613530

(51) Int. Cl. H04L 29/06

(52) U.S. Cl. CPC H04L 65/403
USPC 709/205

(57) ABSTRACT

In a cooperative drawing method using a computing device, a new picture and a drawing group is created. Client computers that join the drawing group are determined. The computing device receives a drawing request from one of the client computers, and assigns a control right and a drawing region of the picture to the client computer. The picture is allocated to the client computer having the control right to draw. According to changes to the picture, drawing codes of the picture are generated. The drawing codes are transferred to all of the client computers. The picture is stored into a storage system of the computing device.

### BACKGROUND

1. Technical Field

Embodiments of the present disclosure relate to network cooperation technology, and particularly to a computing device and a cooperative drawing method of the computing device.

2. Description of Related Art

For fun or business, users sometimes team up to draw a picture together using different client computers via a network. However, the picture may be huge, resulting in the picture not being able to be displayed in real-time.

### BRIEF DESCRIPTION OF THE DRAWINGS

FIG. 1 is one embodiment of an application of a computing device.

FIG. 2 is a block diagram of one embodiment of function modules of a cooperative drawing system in FIG. 1.

FIG. 3 is a flowchart of one embodiment of a cooperative drawing method using the computing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

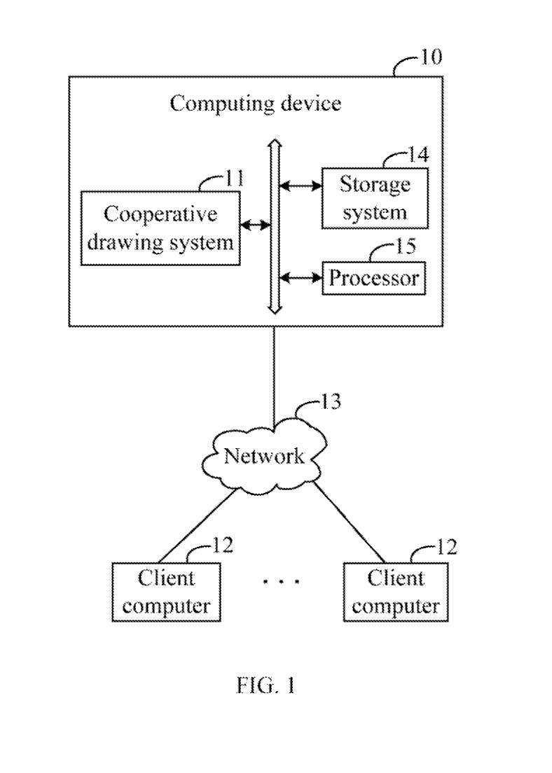

FIG. 1 is a block diagram of one embodiment of a computing device 10. The computing device 10 includes a cooperative drawing system 11. The computing device 10 is connected to a plurality of client computers 12 through a network 13. The cooperative drawing system 11 allows users to draw a picture together via the client computers 12 and display the picture in real-time. The network 13 may be a public or private network.

In the embodiment, the computing device 10 further includes a storage system 14 and at least one processor 15. The storage system 14 may be a dedicated memory, such as an EPROM, a hard disk drive, or flash memory. In some embodiments, the storage system 14 may be an external storage device, such as an external hard disk, a storage card, or a data storage medium.

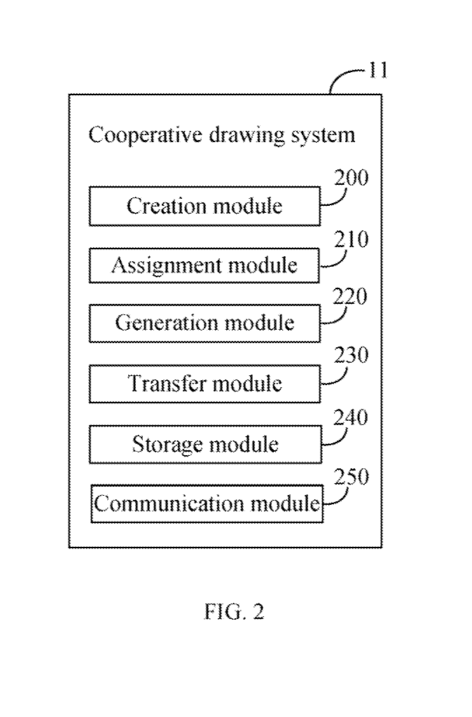

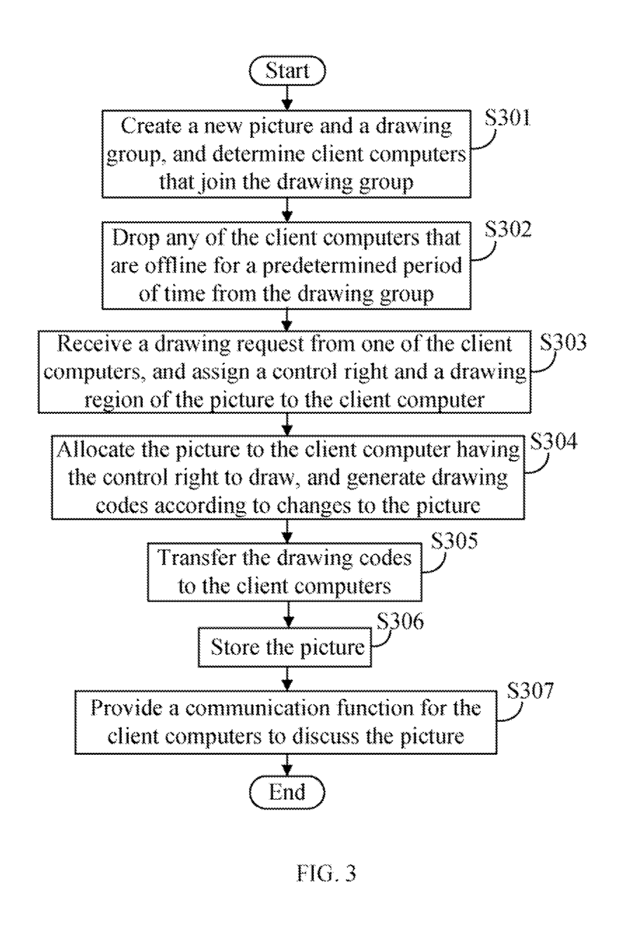

FIG. 2 is a block diagram of one embodiment of function modules of the cooperative drawing system 11 in FIG. 1. The cooperative drawing system 11 includes a creation module 200, an assignment module 210, a generation module 220, a transfer module 230, a storage module 240, and a communication module 250. The modules 200-250 may comprise computerized code in the form of one or more programs that are stored in the storage system 14. The computerized code includes instructions that are executed by the at least one processor 15, to provide the aforementioned functions of the cooperative drawing system 11. A detailed description of the functions of the modules 200-250 is given in reference to FIG. 3.

FIG. 3 is a flowchart of one embodiment of a cooperative drawing method using the computing device 10 of FIG. 1. Depending on the embodiment, additional steps may be added, others removed, and the ordering of the steps may be changed.

In step S301, the creation module 200 creates a new picture and a drawing group, and determines client computers 12 that join the drawing group. In one embodiment, a client computer 12 may send a membership request for joining the drawing group to the computing device 10. The creation module 200 examines the membership request to determine whether the membership request is approvable. If the membership request is approved by the creation module 200, the client computer 12 becomes a member of the drawing group. The membership request may include a user ID, a request time, and an IP address of the client computer 12. The creation module 200 may examine the membership request according to the user ID of the client computer 12.

In step S302, the creation module 200 checks whether the client computers 12 in the drawing group are offline for a predetermined period of time. If any of the client computers 12 in the drawing group are offline for the predetermined period of time, the creation module 200 drops the client computer 12 from the drawing group.

In step S303, the assignment module 210 receives a drawing request from one of the client computers 12 in the drawing group, and assigns a control right and a drawing region of the picture to the client computer 12. In one embodiment, the assignment module 210 assigns the control right to only one client computer 13 in the drawing group at the same time. The assignment module 210 may notify a drawing manager to examine the drawing request and approve or reject the drawing request. The picture may be divided into a plurality of non-overlapping drawing regions by the assignment module 210, each of which is assigned to a unique client computer 12 in the drawing group.

In step S304, the generation module 220 allocates the picture to the client computer 12 having the control right, and generates drawing codes according to changes to the picture. The client computer 12 having the control right may add new content to the picture, delete content from the picture, or modify content in the picture. In one embodiment, the generation module 220 may provide various drawing tools for the client computer 12 having the control right to draw on the picture. For example, the generation module 220 provides shape tools, e.g. a rectangular tool and a circle tool, to draw different shapes in the picture. The generation module 220 may further provide operation tools, e.g. a rotation tool, to operate on the shapes in the picture.

In step S305, the transfer module 230 transfers the drawing codes to the client computers 12 in the drawing group. According to the drawing codes, the client computers 12 in the drawing group generate the picture and display the picture on display devices (not shown) connected to the client computers 12. The drawing codes may be smaller than the picture. Therefore, less data transfer between the computing device 10 and the client computers 12 is achieved. In one embodiment, the transfer module 230 transfers a part of the drawing codes that correspond to the changes of the picture to the client computers 12 in the drawing group.

In step S306, the storage module 240 stores the picture into the storage system 14. In one embodiment, the storage module 240 may notify the client computers 12 in the drawing group to approve or reject the changes to the picture. In one example, if most of the client computers 12 in the drawing group approve the changes to the picture, the picture is stored in the storage system 14.

In step S307, the communication module 250 provides a communication function for the client computers 12 in the drawing group to discuss the picture. In one embodiment, the communication module 250 supports the client computers 12 to transfer text, audio, and video information.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A cooperative drawing method being executed by a processor of a computing device, the method comprising:
creating a picture and a drawing group, and determining client computers that join the drawing group;
receiving a drawing request from one client computer, and assigning a control right and a drawing region of the picture to the client computer;
allocating the picture to the client computer to draw, and generating drawing codes according to changes to the picture;
transferring the drawing codes to all of the client computers; and
storing the picture into a storage system of the computing device.

2. The method of claim 1, further comprising:
providing a communication function for the client computers to discuss the picture.

3. The method of claim 1, further comprising:
dropping any of the client computers that are offline for a predetermined period of time from the drawing group.

4. The method of claim 1, wherein the picture is divided into a plurality of non-overlapping drawing regions, each of which is assigned to a unique client computer in the drawing group.

5. The method of claim 1, further comprising:
notifying the client computers to approve or reject the changes to the picture.

6. A computing device, comprising:
at least one processor; and
a storage system storing a plurality of instructions, which when executed by the at least one processor, cause the at least one processor to:
create a picture and a drawing group, and determine client computers that join the drawing group;
receive a drawing request from one client computer, and assign a control right and a drawing region of the picture to the client computer;
allocate the picture to the client computer to draw, and generate drawing codes according to changes to the picture;
transfer the drawing codes to all of the client computers; and
store the picture into the storage system.

7. The computing device of claim 6, wherein the storage system further stores instructions causing the at least one processor to:
provide a communication function for the client computers to discuss the picture.

8. The computing device of claim 6, wherein the storage system further stores instructions causing the at least one processor to:
drop any of the client computers that are offline for a predetermined period of time from the drawing group.

9. The computing device of claim 6, wherein the picture is divided into a plurality of non-overlapping drawing regions, each of which is assigned to a unique client computer in the drawing group.

10. The computing device of claim 6, wherein the storage system further stores instructions causing the at least one processor to:
notifying the client computers to approve or reject the changes to the picture.

11. A non-transitory computer-readable storage medium storing a set of instructions, the set of instructions capable of being executed by a processor of a computing device to implement a cooperative drawing method, the method comprising:
creating a picture and a drawing group, and determining client computers that join the drawing group;
receiving a drawing request from one client computer, and assigning a control right and a drawing region of the picture to the client computer;
allocating the picture to the client computer having the control right to draw, and generating drawing codes according to changes to the picture;
transferring the drawing codes to all of the client computers; and
storing the picture into a storage system of the computing device.

12. The storage medium of claim 11, wherein the method further comprises:
providing a communication function for the client computers to discuss the picture.

13. The storage medium of claim 11, wherein the method further comprises:
dropping any of the client computers that are offline for a predetermined period of time from the drawing group.

14. The storage medium of claim 11, wherein the picture is divided into a plurality of non-overlapping drawing regions, each of which is assigned to a unique client computer in the drawing group.

15. The storage medium of claim 11, wherein the method further comprises:
notifying the client computers to approve or reject the changes to the picture.
